(19) United States
(12) Patent Application Publication
(10) Pub. No.: US 2026/0067824 A1
(43) Pub. Date: Mar. 5, 2026

(54) SYSTEM AND METHOD FOR WIRELESS COMMUNICATIONS

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/314,904

(22) Filed: Aug. 29, 2025

Related U.S. Application Data
(60) Provisional application No. 63/690,100, filed on Sep. 3, 2024.
(60) Provisional application No. 63/705,177, filed on Oct. 9, 2024.
(60) Provisional application No. 63/759,733, filed on Feb. 18, 2025.

(51) Int. Cl. H04W 52/02; H04L 1/00; H04W 74/0816

(52) U.S. Cl. CPC H04W 52/0261; H04L 1/0003; H04W 74/0816

(57) ABSTRACT

Embodiments of a method and apparatus for wireless communications are disclosed. In an embodiment, a wireless device includes a controller configured to enable or disable a dynamic power save (DPS) mode for the wireless device depending on whether the wireless device is a member of a multiple Basic Service Set Identifier (BSSID) set or a co-hosted BSSID set and on at least one predetermined condition regarding the wireless device, an associated wireless device, or another wireless device in the multiple BSSID set or the co-hosted BSSID set and a wireless transceiver configured to communicate wirelessly depending on whether the DPS mode is enabled or disabled for the wireless device.

### CROSS-REFERENCE TO RELATED APPLICATIONS

This application is entitled to the benefit of U.S. Provisional Patent Application Ser. No. 63/690,100, filed on Sep. 3, 2024, U.S. Provisional Patent Application Ser. No. 63/705,177, filed on Oct. 9, 2024, and U.S. Provisional Patent Application Ser. No. 63/759,733, filed on Feb. 18, 2025, the contents of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. Wireless devices may operate in different modes with different capabilities and power configurations. To facilitate the proper data transmission within a wireless communications system, there is a need for wireless communications technology that can efficiently and securely convey communications signaling information, for example, information related to data, communications links, and/or wireless devices (e.g., operation and/or capability parameters of wireless devices) within the wireless communications system.

### SUMMARY

Embodiments of a method and apparatus for wireless communications are disclosed. In an embodiment, a wireless device includes a controller configured to enable or disable a dynamic power save (DPS) mode for the wireless device depending on whether the wireless device is a member of a multiple Basic Service Set Identifier (BSSID) set or a co-hosted BSSID set and on at least one predetermined condition regarding the wireless device, an associated wireless device, or another wireless device in the multiple BSSID set or the co-hosted BSSID set and a wireless transceiver configured to communicate wirelessly depending on whether the DPS mode is enabled or disabled for the wireless device. Other embodiments are also disclosed.

In an embodiment, the wireless device comprises a mobile access point (AP), and the associated wireless device comprises a wireless non-AP station (STA) associated with the mobile AP.

In an embodiment, an Initial Control Frame (ICF) Required field of the mobile AP is equal to 0, the mobile AP is neither a member of a multiple BSSID AP set nor a member of a co-hosted BSSID AP set, and the controller is further configured to enable the DPS mode for the mobile AP if one of following conditions is true:
all its associated non-AP STAs are DPS assisting non-AP STAs;
all its associated non-AP STAs are configured to perform frame exchanges with the mobile AP in a low-capacity (LC) mode;
BSS operating bandwidth (BW), number of spatial streams (Nss), and modulation coding scheme (MCS) are same as the mobile AP's LC mode operating parameters, while Dynamic Bandwidth Extension (DBE) operating BW, NSS, and MCS are same as the mobile AP's high-capacity (HC) mode operating parameters; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

In an embodiment, an Initial Control Frame (ICF) Required field of the mobile AP is equal to 0, the mobile AP is a member of a multiple BSSID AP set, and the controller is further configured to enable the DPS mode for the mobile AP if each mobile AP in the multiple BSSID AP set satisfies one of following conditions:
all the non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

In an embodiment, an ICF Required field of the mobile AP is equal to 0, the mobile AP is a member of a co-hosted BSSID AP set, and the controller is further configured to enable the DPS mode for the mobile AP if each mobile AP in the co-hosted BSSID AP set satisfies one of following conditions:
all the non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

In an embodiment, an Initial Control Frame (ICF) Required field of the mobile AP is equal to 1, the mobile AP is neither a member of a multiple BSSID AP set nor a member of a co-hosted BSSID AP set, and the controller is further configured to enable the DPS mode for the mobile AP if one of following conditions is true:
all its associated non-AP STAs are DPS assisting non-AP STAs; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

In an embodiment, an Initial Control Frame (ICF) Required field of the mobile AP is equal to 1, the mobile AP is a member of a multiple BSSID AP set, and the controller is further configured to enable the DPS mode for the mobile AP if each mobile AP in the multiple BSSID AP set satisfies one of following conditions:
all the non-AP STAs associated with the each mobile AP are the DPS assisting non-AP STAs; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

In an embodiment, an ICF Required field of the mobile AP is equal to 1, wherein the mobile AP is a member of a co-hosted BSSID AP set, and wherein the controller is further configured to enable the DPS mode for the mobile AP if each mobile AP in the co-hosted BSSID AP set satisfies one of following conditions:
all the non-AP STAs associated with the each mobile AP are the DPS assisting non-AP STAs; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

In an embodiment, all access points (APs) in a multiple BSSID set enable or disable their DPS mode at same time.

In an embodiment, all access points (APs) in a multiple BSSID set enable or disable their Dynamic Bandwidth Extension (DBE) operation at same time.

In an embodiment, the controller is further configured to enable the DPS mode for the wireless device, the controller is further configured to generate an announcement indicating that the DPS mode is enabled for the wireless device, and the wireless transceiver is further configured to transmit the announcement.

In an embodiment, the wireless device is compatible with an Institute of Electrical and Electronics Engineers (IEEE) 802.11 protocol.

In an embodiment, the wireless device comprises an access point (AP) affiliated with a first wireless multi-link device (MLD), the associated wireless device comprises an AP affiliated with a second wireless MLD, and the first wireless MLD are linked to the second wireless MLD through wireless links.

A wireless multi-link device (MLD) includes a controller configured to enable or disable a dynamic power save (DPS) mode for the wireless MLD depending on whether each access point (AP) affiliated with the MLD is a member of a multiple Basic Service Set Identifier (BSSID) set or a co-hosted BSSID set and on at least one predetermined condition regarding an AP or a station (STA) affiliated with the wireless MLD, an associated wireless device, or another wireless device in the multiple BSSID set or the co-hosted BSSID set, and a wireless transceiver configured to communicate wirelessly depending on whether the DPS mode is enabled or disabled for the AP or the STA affiliated with the wireless MLD, where the wireless MLD is compatible with an Institute of Electrical and Electronics Engineers (IEEE) 802.11 protocol.

A method for wireless communications involves at a wireless device, enabling or disabling a dynamic power save (DPS) mode for the wireless device depending on whether the wireless device is a member of a multiple Basic Service Set Identifier (BSSID) set or a co-hosted BSSID set and on at least one predetermined condition regarding the wireless device, an associated wireless device, or another wireless device in the multiple BSSID set or the co-hosted BSSID set and at the wireless device, communicating wirelessly depending on whether the DPS mode is enabled or disabled for the wireless device.

In an embodiment, the wireless device comprises a mobile access point (AP), and the associated wireless device comprises a wireless non-AP station (STA) associated with the mobile AP.

In an embodiment, an ICF Required field of the mobile AP is equal to 0, the mobile AP is neither a member of a multiple BSSID AP set nor a member of a co-hosted BSSID AP set, and at the wireless device, enabling or disabling the DPS mode for the wireless device comprises enabling the DPS mode for the wireless device if one of following conditions is true:
all its associated non-AP STAs are DPS assisting non-AP STAs;
all its associated non-AP STAs are configured to perform frame exchanges with the mobile AP in a low-capacity (LC) mode;
BSS operating bandwidth (BW), number of spatial streams (Nss), and modulation coding scheme (MCS) are same as the mobile AP's LC mode operating parameters, while Dynamic Bandwidth Extension (DBE) operating BW, NSS, and MCS are same as the mobile AP's high-capacity (HC) mode operating parameters; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

In an embodiment, an ICF Required field of the mobile AP is equal to 0, the mobile AP is a member of a multiple BSSID AP set, and at the wireless device, enabling or disabling the DPS mode for the wireless device comprises enabling the DPS mode for the wireless device if each mobile AP in the multiple BSSID AP set satisfies one of following conditions:
all the non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

In an embodiment, an Initial Control Frame (ICF) Required field of the mobile AP is equal to 0, the mobile AP is a member of a co-hosted BSSID AP set, and at the wireless device, enabling or disabling the DPS mode for the wireless device comprises enabling the DPS mode for the wireless device if each mobile AP in the co-hosted BSSID AP set satisfies one of following conditions:
all the non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

In an embodiment, all access points (APs) in a multiple BSSID set enable or disable their DPS mode at same time.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts a state diagram that includes a dynamic power save (DPS) mode being enabled and a DPS mode being disabled in accordance with an embodiment of the invention.

FIG. 5 depicts a state diagram that includes a low-capacity (LC) mode and a high-capacity (HC) mode in accordance with an embodiment of the invention.

FIG. 6 illustrates a frame format in accordance with an embodiment of the invention.

FIG. 7 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

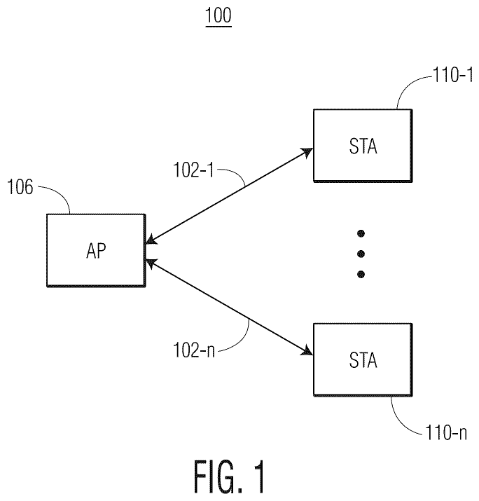

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band. In some embodiments, the AP 106 is the member of a multiple BSSID set or the member of a co-hosted BSSID set. In some embodiments, the AP 106 is neither the member of a multiple BSSID set nor the member of a co-hosted BSSID set.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

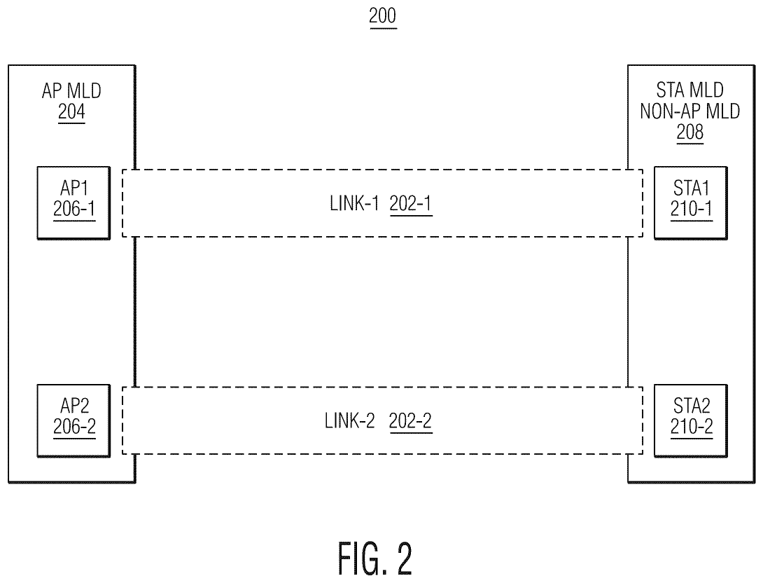

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., association establishment, reordering of frames, etc.) and a link specific part of the AP MLD 204, i.e., the APs 206-1 and 206-2, implement lower layer MAC functionalities (e.g., beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP. In some embodiments, each of the APs 206-1 or 206-2 of the AP MLD 204 is the member of a multiple BSSID set or the member of a co-hosted BSSID set. In some embodiments, each of the APs 206-1 or 206-2 of the AP MLD 204 is neither the member of a multiple BSSID set nor the member of a co-hosted BSSID set.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

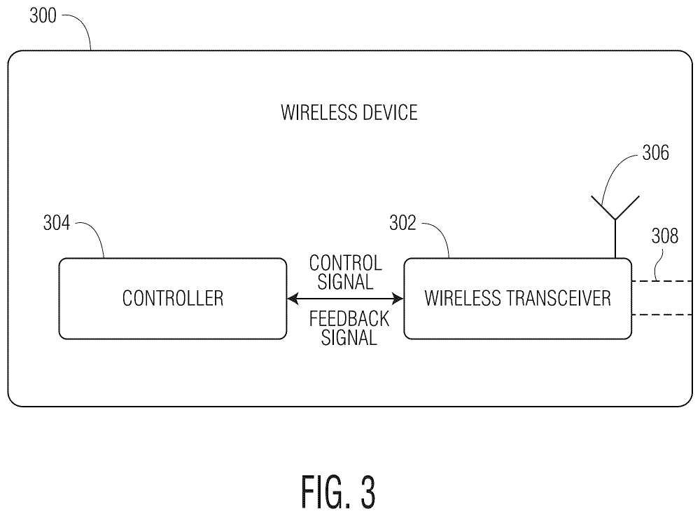

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

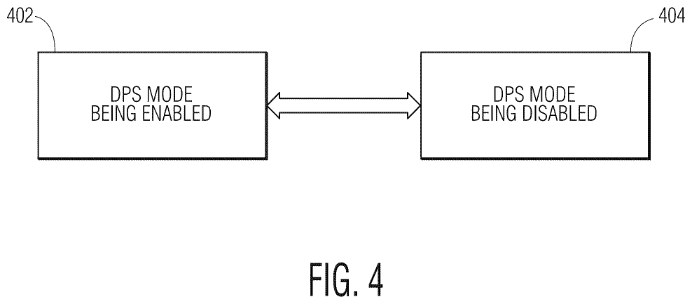

The wireless device 300 can operate under a dynamic power save (DPS) mode. When the wireless device 300 operates under the DPS mode, the wireless device 300 can operate in different capability states with different capabilities. FIG. 4 depicts a state diagram that includes a dynamic power save (DPS) mode being enabled 402 and a dynamic power save mode being disabled 404 in accordance with an embodiment of the invention. In the embodiment depicted in FIG. 4, a wireless device, which may be an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3, can switch between operating in the DPS mode being enabled 402 and operating in the DPS mode being disabled 404. In some embodiments, a wireless device consumes less power in the DPS mode than in the DPS mode being disabled.

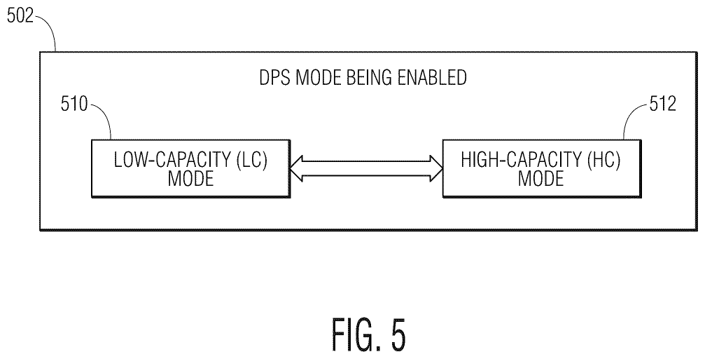

In some embodiments, a device operating under the DPS mode can switch/transition between a low-capability (LC) state/mode and a high-capability (HC) state/mode. FIG. 5 depicts a state diagram that includes a low-capacity (LC) state/mode 510 and a high-capacity (HC) state/mode 512 in accordance with an embodiment of the invention. In the embodiment depicted in FIG. 5, a wireless device, which may be an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3, can switch between operating in the LC state/mode 510 of the DPS mode being enabled 502 and operating in the HC state/mode 512 of the DPS mode being enabled 502. In some embodiments, a device consumes less power in the low-capability state/mode than in the high-capability state/mode. For example, in a low-capability state/mode, a wireless device may detect medium busy/idle and/or receive initial control frame and broadcast frames, and in a high-capability state/mode, the wireless device may execute frame exchanges with high capabilities (e.g., high MAC, >1 Service Set (SS), and/or wider bandwidth (BW)). A wireless device can announce its LC mode operating parameters (bandwidth (BW), a number of spatial streams (Nss), modulation coding scheme (MCS), Physical Layer Protocol Data Unit (PPDU) format etc.) and its HC mode operating parameters (BW, Nss, MCS, PPDU format etc.). A STA that supports AP's DPS mode, also referred to as a DPS assisting STA, can transmit an Initial Control Frame (ICF) to solicit the DPS AP's switch from an LC mode/state to an HC mode/state. In some embodiments, a DPS AP can perform frame exchanges with a DPS assisting STA when the DPS AP operates in an LC mode/state when its ICF Required field is equal to 0. In some embodiments, a DPS AP cannot perform frame exchanges with a DPS assisting STA when the DPS AP operates in an LC mode when its ICF Required field is equal to 1.

Turning back to FIG. 3, the wireless device 300 can enable or disable its DPS mode (e.g., switching between operating in the DPS mode being enabled 402 and operating in the DPS mode being disabled 404). When operating in the DPS mode, the wireless device 300 can switch between operating in an LC state/mode and operating in the HC state/mode (e.g., switch between operating in the LC state/mode 510 and operating in the HC state/mode 512). In accordance with an embodiment of the invention, the controller 304 is configured to enable or disable a dynamic power save (DPS) mode for the wireless device depending on whether the wireless device 300 is a member of a multiple Basic Service Set Identifier (BSSID) set or a co-hosted BSSID set and on at least one predetermined condition regarding the wireless device, an associated wireless device, or another wireless device in the multiple BSSID set or the co-hosted BSSID set, and the wireless transceiver 302 is configured to communicate wirelessly depending on whether the DPS mode is enabled or disabled for the wireless device, for example, through the at least one antenna 306. In some embodiments, a member of a multiple Basic Service Set Identifier (BSSID) set or a co-hosted BSSID set refers to a virtual access point (AP) or a logical BSSID on an AP that is part of a group of BSSIDs broadcast by the same physical AP to support multiple networks. In some embodiments, all members of a multiple BSSID set or a co-hosted BSSID set operate on the same physical radio, channel, and antenna but are logically separated by different SSIDs and BSSIDs. In some embodiments, a single AP can broadcast multiple SSIDs, each with its own unique BSSID, allowing for different network segments or security policies. In some embodiments, the wireless device includes a mobile access point (AP), a regular AP, and the associated wireless device includes a wireless non-AP station (STA) associated with the mobile AP or the regular AP. In some embodiments, if/when an Initial Control Frame (ICF) Required field of the mobile AP is equal to 0, and the mobile AP is neither a member of a multiple BSSID AP set nor a member of a co-hosted BSSID AP set, then the controller 304 can be configured to enable the DPS mode for the mobile AP if one of following conditions is true:
all its associated non-AP STAs are DPS assisting non-AP STAs;
all its associated non-AP STAs are configured to perform frame exchanges with the mobile AP in a low-capacity (LC) mode;
BSS operating bandwidth (BW), number of spatial streams (Nss), and modulation coding scheme (MCS) are the same as the mobile AP's LC mode operating parameters, while Dynamic Bandwidth Extension (DBE) operating BW, NSS, and MCS are the same as the mobile AP's high-capacity (HC) mode operating parameters; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

In some embodiments, if/when an Initial Control Frame (ICF) Required field of the mobile AP is equal to 0, and the mobile AP is a member of a multiple BSSID AP set, then the controller 304 can be configured to enable the DPS mode for the mobile AP (AP1) if each mobile AP (including AP1) in the multiple BSSID AP set satisfies one of following conditions:
all the non-AP STAs associated with each mobile AP are the DPS assisting non-AP STAS;
all the non-AP STAs associated with each mobile AP are configured to perform the frame exchanges with each mobile AP in a low-capacity (LC) mode;
BSS operating bandwidth (BW), number of spatial streams (Nss), and modulation coding scheme (MCS) are the same as each mobile AP's LC mode operating parameters, while Dynamic Bandwidth Extension (DBE) operating BW, NSS, and MCS are the same as each mobile AP's high-capacity (HC) mode operating parameters; and
each mobile AP has a value zero in its DPS Padding Delay field and has a value one in its Transmit opportunity (TXOP) Duration Request to Send (RTS) Threshold field, and all the non-AP STAs associated with the each other mobile AP are High Efficiency (HE) STAs.

In some embodiments, if/when an Initial Control Frame (ICF) Required field of the mobile AP is equal to 0, and the mobile AP is a member of a co-hosted BSSID AP set, then the controller 304 can be configured to enable the DPS mode for the mobile AP (AP1) if each mobile AP (including AP1) in the co-hosted BSSID AP set satisfies one of following conditions:
all the non-AP STAs associated with each mobile AP are the DPS assisting non-AP STAs;
all the non-AP STAs associated with each mobile AP are configured to perform the frame exchanges with each mobile AP in a low-capacity (LC) mode;
BSS operating bandwidth (BW), number of spatial streams (Nss), and modulation coding scheme (MCS) are the same as each mobile AP's LC mode operating parameters, while Dynamic Bandwidth Extension (DBE) operating BW, NSS, and MCS are the same as each mobile AP's high-capacity (HC) mode operating parameters; and
each mobile AP has a value zero in its DPS Padding Delay field and has a value one in its Transmit opportunity (TXOP) Duration Request to Send (RTS) Threshold field, and all the non-AP STAs associated with each mobile AP are High Efficiency (HE) STAs.

In some embodiments, if/when an Initial Control Frame (ICF) Required field of the mobile AP is equal to 1, and the mobile AP is neither a member of a multiple BSSID AP set nor a member of a co-hosted BSSID AP set, then the controller 304 can be configured to enable the DPS mode for the mobile AP if one of the following conditions is true:
all its associated non-AP STAs are DPS assisting non-AP STAs; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

In some embodiments, if/when an Initial Control Frame (ICF) Required field of the mobile AP is equal to 1, and the mobile AP is a member of a multiple BSSID AP set, then the controller 304 can be configured to enable the DPS mode for the mobile AP (AP1) if each mobile AP (including AP1) in the multiple BSSID AP set satisfies one of the following conditions:
all the non-AP STAs associated with each mobile AP are the DPS assisting non-AP STAs; and
each mobile AP has a value zero in its DPS Padding Delay field and has a value one in its Transmit opportunity (TXOP) Duration Request to Send (RTS) Threshold field, and all the non-AP STAs associated with each mobile AP are High Efficiency (HE) STAs.

In some embodiments, if/when an Initial Control Frame (ICF) Required field of the mobile AP is equal to 1, and the mobile AP is a member of a co-hosted BSSID AP set, then the controller 304 can be configured to enable the DPS mode for the mobile AP (AP1) if each mobile AP (including AP1) in the co-hosted BSSID AP set satisfies one of the following conditions:
all the non-AP STAs associated with each mobile AP are the DPS assisting non-AP STAs; and
each mobile AP has a value zero in its DPS Padding Delay field and has a value one in its Transmit opportunity (TXOP) Duration Request to Send (RTS) Threshold field, and all the non-AP STAs associated with each mobile AP are High Efficiency (HE) STAs.

In some embodiments, all access points (APs) in a multiple BSSID set enable or disable their DPS mode at same time. In some embodiments, all access points (APs) in a multiple BSSID set enable or disable their Dynamic Bandwidth Extension (DBE) operation at same time. In some embodiments, the controller 304 is further configured to enable the DPS mode for the wireless device, the controller 304 is further configured to generate an announcement indicating that the DPS mode is enabled for the wireless device, and the wireless transceiver 302 is further configured to transmit the announcement, for example, through the antenna 306. In some embodiments, the wireless device 300 is compatible with an Institute of Electrical and Electronics Engineers (IEEE) 802.11 protocol. In some embodiments, the wireless device 300 includes an AP affiliated with a first wireless multi-link device (MLD), the associated wireless device includes an AP affiliated with a second wireless MLD, and the first wireless MLD are linked to the second wireless MLD through wireless links. In some embodiments, a wireless multi-link device (MLD) includes a controller configured to enable or disable a dynamic power save (DPS) mode for the wireless MLD depending on whether each AP affiliated with the MLD is a member of a multiple Basic Service Set Identifier (BSSID) set or a co-hosted BSSID set and on at least one predetermined condition regarding an AP or a STA affiliated with the wireless MLD, an associated wireless device, or another wireless device in the multiple BSSID set or the co-hosted BSSID set and a wireless transceiver configured to communicate wirelessly depending on whether the DPS mode is enabled or disabled for the AP or STA affiliated with the wireless MLD, where the wireless MLD is compatible with an Institute of Electrical and Electronics Engineers (IEEE) 802.11 protocol. In some embodiments, a mobile AP always has ICF Required reserved and the discussions being applied to ICF Required equal to 0 are applied to a mobile AP always has ICF Required reserved. In some embodiments, the discussion mentioned in this paragraph for a mobile AP is applied to a regular AP.

In some implementations, in an (mobile) AP device, single (mobile) AP may exist. In an (mobile) AP device, multiple virtual (mobile) APs may be in one multiple BSSID set. All such (mobile) APs can share the same radio, operating channels. In a (mobile) AP device, multiple virtual (mobile) APs may be in one co-hosted BSSID set. All such (mobile) APs can share the same radio, operating channels. A (mobile) AP that supports DPS can enable its DPS mode. The (mobile) AP that enables its DPS mode is called a DPS (mobile) AP. For example, a DPS AP is in LC (low-capability) mode/state for monitoring the medium, and is in HC (high-capability) mode/state for frame exchanges. The DPS AP can announce its LC mode operating parameters (bandwidth (BW), a number of spatial streams (Nss), modulation coding scheme (MCS), Physical Layer Protocol Data Unit (PPDU) format etc.) and its HC mode operating parameters (BW, Nss, MCS, PPDU format etc.). A STA that supports AP's DPS mode is called a DPS assisting STA. A DPS assisting STA can transmit an Initial Control Frame (ICF) to solicit the DPS AP's switch from an LC mode/state to an HC mode/state. The DPS AP can transmit an Initial Control Reply (ICR) solicited by the ICF. A DPS assisting STA can perform the frame exchanges with a DPS (mobile) AP operating in an LC mode/state if the DPS AP announces ICF Required equal to 0. A DPS STA cannot perform the frame exchanges with a DPS (mobile) AP operating in an LC mode if the AP announce its ICF Required field equal to 1.

Some implementations of DBE (Dynamic Bandwidth Extension) Assisting DPS Mode Enabling of a (mobile) AP with ICF Required Field Equal to 0, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, a (mobile) AP with its ICF Required field equal to 0 that is neither a member of a multiple BSSID mobile AP set nor a member of a co-hosted mobile AP set may enable its DPS mode if one of the following conditions is true:
all its associated non-AP STAs are the DPS assisting non-AP STAs;
all its associated non-AP STAs are configured to perform the frame exchanges with the mobile AP in the LC mode;
the BSS operating BW, Nss, MCS are the same as the AP's LC mode parameters, while the DBE operating BW, Nss, MCS are the same as the AP's HC mode operating parameters;
the (mobile) AP has the value zero in its DPS Padding Delay field and has the value 1 in its Transmit opportunity (TXOP) Duration Request to Send (RTS) Threshold field, and all its associated STAs are High Efficiency (HE) STAs.

In some embodiments, a (mobile) AP (AP1) with its ICF Required field equal to 0 that is a member of a multiple BSSID mobile AP set may enable its DPS mode if each (mobile) AP (AP2) (including AP1) in the multiple BSSID mobile AP set satisfies one of the following conditions:
all the non-AP STAs associated with the AP (AP2) are the DPS assisting non-AP STAs;
all the non-AP STAs associated with the AP (AP2) are configured to perform the frame exchanges with the AP in the LC mode;
the BSS operating BW, Nss, MCS are the same as the AP (AP2)'s LC mode parameters, while the DBE operating BW, Nss, MCS are the same as the AP (AP2)'s HC mode operating parameters;
the AP (AP2) has the value zero in its DPS Padding Delay field and has the value 1 in its TXOP Duration RTS Threshold field, and all the non-AP STAs associated with the AP are the HE STAs.

In some embodiments, a (mobile) AP (AP1) with its ICF Required field equal to 0 that is a member of a co-hosted mobile AP set may enable its DPS mode if each AP (AP2) in including AP1 in the co-hosted mobile AP set satisfies one of the following conditions:
all the non-AP STAs associated with the AP (AP2) are the DPS assisting non-AP STAs;
all the non-AP STAs associated with the AP (AP2) are configured to perform the frame exchanges with the AP (AP2) in the LC mode;
the BSS operating BW, Nss, MCS are the same as the AP (AP2)'s LC mode parameters, while the DBE operating BW, NSS, MCS are the same as the AP (AP2)'s HC mode operating parameters;
the AP (AP2) has the value zero in its DPS Padding Delay field and has the value 1 in its TXOP Duration RTS Threshold field, and all the non-AP STAs associated with the AP (AP2) are the HE STAs.

Some implementations of DPS Mode Enabling of a (mobile) AP with ICF Required Field Equal to 1, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, a (mobile) AP with its ICF Required field equal to 1 that is neither a member of a multiple BSSID mobile AP set nor a member of a co-hosted mobile AP set may enable its DPS mode if one of the following conditions is true:
all its associated non-AP STAs are the DPS assisting non-AP STAs;
the (mobile) AP has the value zero in its DPS Padding Delay field and has the value 1 in its TXOP Duration RTS Threshold field, and all its associated STAs are the HE STAs.

In some embodiments, a (mobile) AP (AP1) with its ICF Required field equal to 1 that is a member of a multiple BSSID mobile AP set may enable its DPS mode if each (mobile) AP (AP2) including AP1 in the multiple BSSID mobile AP set satisfies one of the following conditions:
all the non-AP STAs associated with the AP (AP2) are the DPS assisting non-AP STAs;
the AP (AP2) has the value zero in its DPS Padding Delay field and has the value 1 in its TXOP Duration RTS Threshold field, and all the non-AP STAs associated with the AP are the HE STAs.

In some embodiments, a (mobile) AP (AP1) with its ICF Required field equal to 1 that is a member of a co-hosted mobile AP set may enable its DPS mode if each AP (AP2) including AP1 in the co-hosted mobile AP set satisfies one of the following conditions:
all the non-AP STAs associated with the AP (AP2) are the DPS assisting non-AP STAs;
the AP (AP2) has the value zero in its DPS Padding Delay field and has the value 1 in its TXOP Duration RTS Threshold field, and all the non-AP STAs associated with the AP (AP2) are the HE STAs.

Some implementations of DPS Mode of Virtual APs, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, all the APs in one multiple BSSID set need to enable/disable their DPS mode at the same time. Otherwise, the power save cannot be achieved.

In some embodiments, if target beacon transmission time (TBTT) is used by an AP to announce the time when it enables/disables its low capability mode, the APs of a co-hosted BSSID set cannot announce the same switch time. In such case, the time difference between AP1's TBTT for AP1 to enable/disable its DPS mode and AP2's TBTT for AP2 to enable/disable its low-capability (LC) mode is less than AP1's BI (beacon interval) and AP2's BI. In some embodiments, when at least one virtual AP is not in DPS mode, all the virtual APs that enable DPS mode is not allowed to use the LC mode for medium monitoring.

In some embodiments, if timing synchronization function (TSF) time is used by an AP to announce the time when it enables/disables the DPS mode, the APs of a co-hosted BSSID set announce their TSF time values that indicate the same time.

In some embodiments, if TSF time is used by an AP to announce the time when it enables/disables DPS mode, the APs of a multiple BSSID set announce their TSF time values that indicate the same time.

Some implementations of AP TXOP Duration RTS Threshold for AP's DPS Operation, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, an AP with DPS padding delay equal to 0 announces its TXOP Duration RTS Threshold equal to 1 if all its associated STAs are HE STAs. Subsequently, the AP can enable its DPS mode. In some embodiments, each STA transmits an RTS to the AP to initiate a TXOP for the frame exchanges with the AP. The RTS/CTS (Clear To Send) can be used for AP's switch from the LC mode to the HC mode. With such announcement, an AP can announce its DPS enabling even if there are associated STAs that are not DPS assisting STAs.

Some implementations of AP Operating Parameters Update for AP's DPS Operation, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, an AP with its ICF Required field equal to 0 announces its operating BW and Nss the same as its BW and Nss in its LC mode by using an Operation Mode (OM) Control field or an Operation Mode Notification frame for each STA that is not a DPS assisting STA. Subsequently, the AP can enable its DPS mode. With such announcement, an AP can announce its DPS enabling even if there are associated STAs that are not DPS assisting STAs.

Some implementations of Dynamic Bandwidth Extension (DBE) Operating BW Announcement for AP's DPS Operation, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, an AP with its ICF Required field equal to 0 enables its DBE operation and its BSS Operation element with the BSS operating BW, Nss, MCS the same as its BW, Nss and MCS in its LC mode. Then the AP can enable its DPS mode. With such announcement, an AP can announce its DPS enabling even if there are associated STAs that are not DPS assisting STAs.

In some embodiments, a STA that is a DPS assisting STA enables its DBE.

In some embodiments, a STA that is not a DPS assisting STA is not allowed to enable its DBE.

Some implementations of Dynamic Bandwidth Extension (DBE) Operating BW Announcement, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, in Option 1, a new defined element announces the BSS operating channel with the BW wider than the BSS operating channel BW of EHT/HE Operation element and optional channel puncture information. In some embodiments, if/when the new defined element carries the channel puncture information, the channel puncture announced by the new defined element whose channel BW is the same as the channel BW of an EHT Operation element and covers primary channel is the same the channel puncture announced by the new defined element.

In some embodiments, in Option 2, the UHR Operation element announces the BSS operating channel with the BW wider than the BSS operating channel BW of EHT/HE Operation element and optional channel puncture information. In some embodiments, if/when the EHT Operation element carries the channel puncture information, the channel puncture announced by a UHR Operation element whose channel BW is the same as the channel BW of an EHT Operation element and covers primary channel is the same the channel puncture announced by the EHT Operation element.

Some implementations of DBE Enabling of Virtual APs, for example, by the wireless communications system 100 depicted in FIG. 1, each AP affiliated with an MLD in the multi-link (ML) communications system 200 depicted in FIG. 2, and/or the wireless device 300 depicted in FIG. 3 are described as follows.

In some embodiments, all the APs in one multiple BSSID set need to be enable/disable their DBE operation at the same time. Otherwise, the power save cannot be achieved.

In some embodiments, if TBTT is used by an AP to announce the time when it enables/disables its DBE operation, the APs of a co-hosted BSSID set cannot announce the same switch time. In such case, the time difference between AP1's TBTT for AP1 to enable/disable its DBE and AP2's TBTT for AP2 to enable/disable its DBE is less than AP1's BI (beacon interval) and AP2's BI. In some embodiments, when at least one virtual AP enables DBE, the DBE's BW, Nss, MCS are enabled in the AP device.

In some embodiments, if TSF time is used by an AP to announce the time when it enables/disables DBE, the APs of a co-hosted BSSID set announce their TSF time values that indicate the same time.

In some embodiments, if TSF time is used by an AP to announce the time when it enables/disables DBE, the APs of a multiple BSSID set announce their TSF time values that indicate the same time.

In some embodiments, a method of performing frame exchanges between a first device and a second device with narrow BW medium monitoring+1 SS+low data rate and wide BW+>1 SS+high MCS frame exchanges where the first device and the second device can perform BW negotiation for the wide BW frame exchanges, the method comprising either of: announcing, by the second device, whether it supports the initiating control frame to trigger the first device's switch from low-capability mode to high-capability mode, enabling, by the first device, its low-capability mode, transmitting, by the second device, the initiating control frame to the first device that enables its low-capability mode in order to perform the frame exchanges with the first device. In some embodiments, if all first devices sharing the same radio frequency (RF) chains (belonging to multiple BSSID set or co-hosted AP set) have all their associated second devices supporting the transmission of initiating control frame for first device's switch from low-capability mode to high-capability mode, the first devices can enable its low-capability mode. In some embodiments, if one first device belonging to multiple BSSID set or co-hosted AP set enables its low-capability mode, another first device belonging to multiple BSSID set or co-hosted AP set also enables its low-capability mode. In some embodiments, the first devices belonging to multiple BSSID set or co-hosted AP set announce the same padding delay for switching from a low-capability mode to a high-capability mode and the same transition delay for switching from the high-capability mode to the low-capability mode.

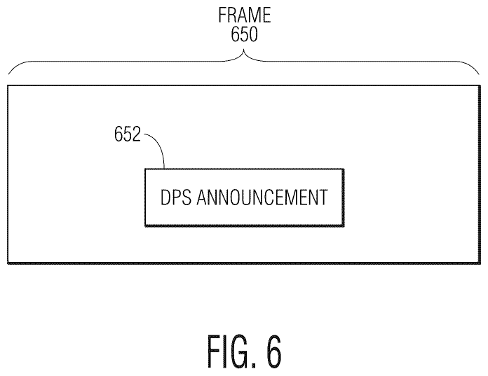

FIG. 6 illustrates a frame format 650 in accordance with an embodiment of the invention. The frame format 650 illustrated in FIG. 6 may be used by the wireless communications system 100 depicted in FIG. 1, the multi-link (ML) communications system 200 depicted in FIG. 2, and/or the wireless device 300 depicted in FIG. 3. In the embodiment depicted in FIG. 6, the frame format 650 includes a DPS announcement 652 containing information regarding whether a wireless device enables or disables its DPS mode. In some embodiments, the DPS announcement 652 is contained in a capability element (not shown in the figure) or other element.

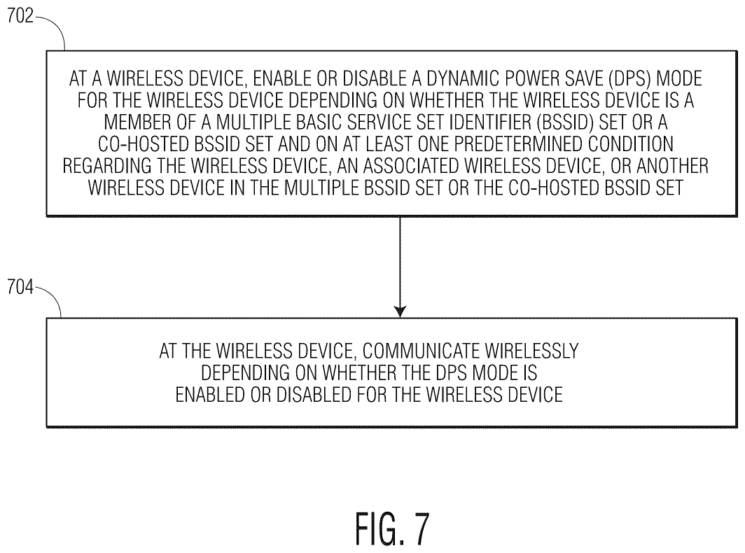

FIG. 7 is a process flow diagram of a method for wireless communications in accordance with an embodiment of the invention. At block 702, at a wireless device, a dynamic power save (DPS) mode is enabled or disabled for the wireless device depending on whether the wireless device is a member of a multiple Basic Service Set Identifier (BSSID) set or a co-hosted BSSID set and on at least one predetermined condition regarding the wireless device, an associated wireless device, or another wireless device in the multiple BSSID set or the co-hosted BSSID set. At block 704, at the wireless device, data is communicated wirelessly depending on whether the DPS mode is enabled or disabled for the wireless device. In some embodiments, the wireless device includes a mobile access point (AP), and the associated wireless device includes a wireless non-AP station (STA) associated with the mobile AP. In some embodiments, an Initial Control Frame (ICF) Required field of the mobile AP is equal to 0, the mobile AP is neither a member of a multiple BSSID AP set nor a member of a co-hosted BSSID AP set, and the DPS mode for the mobile AP is enabled if one of the following conditions is true:
all its associated non-AP STAs are DPS assisting non-AP STAs;
all its associated non-AP STAs are configured to perform frame exchanges with the mobile AP in a low-capacity (LC) mode;
BSS operating bandwidth (BW), number of spatial streams (Nss), and modulation coding scheme (MCS) are the same as the mobile AP's LC mode operating parameters, while Dynamic Bandwidth Extension (DBE) operating BW, NSS, and MCS are the same as the mobile AP's high-capacity (HC) mode operating parameters; and
the mobile AP has a value zero in its DPS Padding Delay field and has a value one in its Transmit opportunity (TXOP) Duration Request to Send (RTS) Threshold field, and all its associated STAs are High Efficiency (HE) STAs. In some embodiments, an Initial Control Frame (ICF) Required field of the mobile AP is equal to 0, the mobile AP is a member of a multiple BSSID AP set, and the DPS mode for the mobile AP is enabled if each mobile AP in the multiple BSSID AP set satisfies one of the following conditions:
all the non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are the same as the each mobile AP's LC mode operating parameters, while Dynamic Bandwidth Extension (DBE) operating BW, NSS, and MCS are the same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs. In some embodiments, an Initial Control Frame (ICF) Required field of the mobile AP is equal to 0, the mobile AP is a member of a co-hosted BSSID AP set, and the DPS mode for the mobile AP is enabled if each mobile AP in the co-hosted BSSID AP set satisfies one of the following conditions:
all the non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are the same as the each mobile AP's LC mode operating parameters, while Dynamic Bandwidth Extension (DBE) operating BW, NSS, and MCS are the same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs. In some embodiments, an Initial Control Frame (ICF) Required field of the mobile AP is equal to 1, the mobile AP is neither a member of a multiple BSSID AP set nor a member of a co-hosted BSSID AP set, and the DPS mode for the mobile AP is enabled if one of the following conditions is true:
all its associated non-AP STAs are DPS assisting non-AP STAs; and
the mobile AP has a value zero in its DPS Padding Delay field and has a value one in its Transmit opportunity (TXOP) Duration Request to Send (RTS) Threshold field, and all its associated STAs are High Efficiency (HE) STAs. In some embodiments, an Initial Control Frame (ICF) Required field of the mobile AP is equal to 1, the mobile AP is a member of a multiple BSSID AP set, and the controller is further configured to enable the DPS mode for the wireless device if each mobile AP in the multiple BSSID AP set satisfies one of the following conditions:
all the non-AP STAs associated with the each mobile AP are the DPS assisting non-AP STAs; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs. In some embodiments, an Initial Control Frame (ICF) Required field of the mobile AP is equal to 1, the mobile AP is a member of a co-hosted BSSID AP set, and the DPS mode for the mobile AP is enabled if each mobile AP in the co-hosted BSSID AP set satisfies one of the following conditions:
all the non-AP STAs associated with the each mobile AP are the DPS assisting non-AP STAs; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs. In some embodiments, all access points (APs) in a multiple BSSID set enable or disable their DPS mode at same time. In some embodiments, all access points (APs) in a multiple BSSID set enable or disable their Dynamic Bandwidth Extension (DBE) operation at same time. In some embodiments, the DPS mode is enabled for the wireless device, an announcement indicating that the DPS mode is enabled for the wireless device is generated, and the announcement is transmitted. In some embodiments, the wireless device is compatible with an Institute of Electrical and Electronics Engineers (IEEE) 802.11 protocol. In some embodiments, the wireless device includes a first wireless multi-link device (MLD), the associated wireless device includes a second wireless MLD, and the first wireless MLD are linked to the second wireless MLD through wireless links. The wireless device, the associated wireless device, and/or another wireless device in the multiple BSSID set or the co-hosted BSSID set may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to enable or disable a dynamic power save (DPS) mode for the wireless device depending on whether the wireless device is a member of a multiple Basic Service Set Identifier (BSSID) set or a co-hosted BSSID set and on at least one predetermined condition regarding the wireless device, an associated wireless device, or another wireless device in the multiple BSSID set or the co-hosted BSSID set; and
a wireless transceiver configured to communicate wirelessly depending on whether the DPS mode is enabled or disabled for the wireless device.

2. The wireless device of claim 1, wherein the wireless device comprises a mobile access point (AP), and wherein the associated wireless device comprises a wireless non-AP station (STA) associated with the mobile AP.

3. The wireless device of claim 2, wherein an Initial Control Frame (ICF) Required field of the mobile AP is equal to 0, wherein the mobile AP is neither a member of a multiple BSSID AP set nor a member of a co-hosted BSSID AP set, and wherein the controller is further configured to enable the DPS mode for the mobile AP if one of following conditions is true:
all its associated non-AP STAs are DPS assisting non-AP STAs;
all its associated non-AP STAs are configured to perform frame exchanges with the mobile AP in a low-capacity (LC) mode;
BSS operating bandwidth (BW), number of spatial streams (Nss), and modulation coding scheme (MCS) are same as the mobile AP's LC mode operating parameters, while Dynamic Bandwidth Extension (DBE) operating BW, NSS, and MCS are same as the mobile AP's high-capacity (HC) mode operating parameters; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

4. The wireless device of claim 2, wherein an Initial Control Frame (ICF) Required field of the mobile AP is equal to 0, wherein the mobile AP is a member of a multiple BSSID AP set, and wherein the controller is further configured to enable the DPS mode for the mobile AP if each mobile AP in the multiple BSSID AP set satisfies one of following conditions:
all non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

5. The wireless device of claim 2, wherein an Initial Control Frame (ICF) Required field of the mobile AP is equal to 0, wherein the mobile AP is a member of a co-hosted BSSID AP set, and wherein the controller is further configured to enable the DPS mode for the mobile AP if each mobile AP in the co-hosted BSSID AP set satisfies one of following conditions:
all non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

6. The wireless device of claim 2, wherein an Initial Control Frame (ICF) Required field of the mobile AP is equal to 1, wherein the mobile AP is neither a member of a multiple BSSID AP set nor a member of a co-hosted BSSID AP set, and wherein the controller is further configured to enable the DPS mode for the mobile AP if one of following conditions is true:
all its associated non-AP STAs are DPS assisting non-AP STAs; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

7. The wireless device of claim 2, wherein an Initial Control Frame (ICF) Required field of the mobile AP is equal to 1, wherein the mobile AP is a member of a multiple BSSID AP set, and wherein the controller is further configured to enable the DPS mode for the mobile AP if each mobile AP in the multiple BSSID AP set satisfies one of following conditions:
all non-AP STAs associated with the each mobile AP are the DPS assisting non-AP STAs; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

8. The wireless device of claim 2, wherein an Initial Control Frame (ICF) Required field of the mobile AP is equal to 1, wherein the mobile AP is a member of a co-hosted BSSID AP set, and wherein the controller is further configured to enable the DPS mode for the mobile AP if each mobile AP in the co-hosted BSSID AP set satisfies one of following conditions:
all non-AP STAs associated with the each mobile AP are the DPS assisting non-AP STAs; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

9. The wireless device of claim 1, wherein all access points (APs) in a multiple BSSID set enable or disable their DPS mode at same time.

10. The wireless device of claim 1, wherein all access points (APs) in a multiple BSSID set enable or disable their Dynamic Bandwidth Extension (DBE) operation at same time.

11. The wireless device of claim 1, wherein the controller is further configured to enable the DPS mode for the wireless device, wherein the controller is further configured to generate an announcement indicating that the DPS mode is enabled for the wireless device, and wherein the wireless transceiver is further configured to transmit the announcement.

12. The wireless device of claim 1, wherein the wireless device is compatible with an Institute of Electrical and Electronics Engineers (IEEE) 802.11 protocol.

13. The wireless device of claim 1, wherein the wireless device comprises an access point (AP) affiliated with a first wireless multi-link device (MLD), wherein the associated wireless device comprises an AP affiliated with a second wireless MLD, and wherein the first wireless MLD are linked to the second wireless MLD through a plurality of wireless links.

14. A wireless multi-link device (MLD) comprising:
a controller configured to enable or disable a dynamic power save (DPS) mode for the wireless MLD depending on whether each access point (AP) affiliated with the MLD is a member of a multiple Basic Service Set Identifier (BSSID) set or a co-hosted BSSID set and on at least one predetermined condition regarding an AP or a station (STA) affiliated with the wireless MLD, an associated wireless device, or another wireless device in the multiple BSSID set or the co-hosted BSSID set; and
a wireless transceiver configured to communicate wirelessly depending on whether the DPS mode is enabled or disabled for the AP or the STA affiliated with the wireless MLD,
wherein the wireless MLD is compatible with an Institute of Electrical and Electronics Engineers (IEEE) 802.11 protocol.

15. A method for wireless communications, the method comprising:
at a wireless device, enabling or disabling a dynamic power save (DPS) mode for the wireless device depending on whether the wireless device is a member of a multiple Basic Service Set Identifier (BSSID) set or a co-hosted BSSID set and on at least one predetermined condition regarding the wireless device, an associated wireless device, or another wireless device in the multiple BSSID set or the co-hosted BSSID set; and
at the wireless device, communicating wirelessly depending on whether the DPS mode is enabled or disabled for the wireless device.

16. The method of claim 15, wherein the wireless device comprises a mobile access point (AP), and wherein the associated wireless device comprises a wireless non-AP station (STA) associated with the mobile AP.

17. The method of claim 16, wherein an Initial Control Frame (ICF) Required field of the mobile AP is equal to 0, wherein the mobile AP is neither a member of a multiple BSSID AP set nor a member of a co-hosted BSSID AP set, and wherein at the wireless device, enabling or disabling the DPS mode for the wireless device comprises enabling the DPS mode for the wireless device if one of following conditions is true:
all its associated non-AP STAs are DPS assisting non-AP STAs;
all its associated non-AP STAs are configured to perform frame exchanges with the mobile AP in a low-capacity (LC) mode;
BSS operating bandwidth (BW), number of spatial streams (Nss), and modulation coding scheme (MCS) are same as the mobile AP's LC mode operating parameters, while Dynamic Bandwidth Extension (DBE) operating BW, NSS, and MCS are same as the mobile AP's high-capacity (HC) mode operating parameters; and
the mobile AP has a value zero in its DPS Padding Delay field and has a value one in its Transmit opportunity (TXOP) Duration Request to Send (RTS) Threshold field, and all its associated STAs are High Efficiency (HE) STAs.

18. The method of claim 16, wherein an Initial Control Frame (ICF) Required field of the mobile AP is equal to 0, wherein the mobile AP is a member of a multiple BSSID AP set, and wherein at the wireless device, enabling or disabling the DPS mode for the wireless device comprises enabling the DPS mode for the wireless device if each mobile AP in the multiple BSSID AP set satisfies one of following conditions:
all non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

19. The method of claim 16, wherein an Initial Control Frame (ICF) Required field of the mobile AP is equal to 0, wherein the mobile AP is a member of a co-hosted BSSID AP set, and wherein at the wireless device, enabling or disabling the DPS mode for the wireless device comprises enabling the DPS mode for the wireless device if each mobile AP in the co-hosted BSSID AP set satisfies one of following conditions:
all non-AP STAs associated with the each mobile AP are the DPS assisting non-AP STAs;
all the non-AP STAs associated with the each mobile AP are configured to perform the frame exchanges with the each mobile AP in a low-capacity (LC) mode;
BSS operating bandwidth (BW), number of spatial streams (Nss), and modulation coding scheme (MCS) are same as the each mobile AP's LC mode operating parameters, while Dynamic Bandwidth Extension (DBE) operating BW, NSS, and MCS are same as the each mobile AP's high-capacity (HC) mode operating parameters; and
the each mobile AP has a value zero in its DPS Padding Delay field and has a value one in its Transmit opportunity (TXOP) Duration Request to Send (RTS) Threshold field, and all the non-AP STAs associated with the each mobile AP are High Efficiency (HE) STAs.

20. The method of claim 15, wherein all access points (APs) in a multiple BSSID set enable or disable their DPS mode at same time.
